(19) United States
(12) Patent Application Publication
(10) Pub. No.: US 2016/0217736 A1
(43) Pub. Date: Jul. 28, 2016

(54) DISPLAY DEVICE AND METHOD OF DRIVING THE SAME

(71) Applicant: Japan Display Inc., Tokyo (JP)

(72) Inventors: Hiroshi NAKAYAMA, Tokyo (JP); Duzen PENG, Tokyo (JP); Ilin WU, Tokyo (JP); Makoto SHIBUSAWA, Tokyo (JP)

(21) Appl. No.: 15/001,594

(22) Filed: Jan. 20, 2016

(30) Foreign Application Priority Data
Jan. 26, 2015 (JP) 2015-012256

(51) Int. Cl. G09G 3/32

(52) U.S. Cl. CPC G09G 3/3233; G09G 3/3266; G09G 2300/0842; G09G 2310/0202; G09G 2310/08; G09G 2330/028

(57) ABSTRACT

A display device with a plurality of pixels including a video signal wire, a first power supply wire connecting via a first switch a first power supply outputting a first voltage and connecting via a second switch a second power supply outputting a second voltage different to the first voltage, a second power supply wire connecting a third power supply outputting a third voltage different to the first voltage and the second voltage, a light emitting element arranged between the first power supply wire and the second power supply wire, a drive transistor controlling a value of a current supplied to the light emitting element, and a third switch arranged between the video signal wire and the drive transistor, the first power supply wire becoming the second voltage in a first time period within 1 horizontal scanning period, and becoming the first voltage in a remaining second time period.

### CROSS REFERENCE TO RELATED APPLICATIONS

This application is based upon and claims the benefit of priority from the prior Japanese Patent Application No. 2015-012256, filed on 26 Jan. 2015, the entire contents of which are incorporated herein by reference.

### FIELD

The preset invention is related to a display device arranged with a display part including a plurality of pixels. In particular, the present invention is related to an EL display device including a light emitting element such as an electro luminescence element in each pixel.

### BACKGROUND

An electroluminescence element (referred to herein as [EL element]) is known as a light emitting element which utilizes an electroluminescence phenomenon. The EL element has a structure in which an EL material which becomes a light emitting material is sandwiched between an anode and a cathode and emits light at a wavelength according to the type of EL material.

When a certain voltage is applied between the anode and cathode of the EL element, a current flows between the anode and cathode and the EL material emits light at a luminosity according to the value of the current. Therefore, by controlling the value of the current supplied to the EL element, it is possible to make the EL element emit light at a desired luminosity.

A pixel circuit of a conventional display device includes a drive transistor which controls the value of a current supplied to an EL element in each pixel display devices in recent years, because gradation control capabilities at a high level are being demanded, the drive transistor is required to very finely control a current value. As a result, a technology for removing the effects of a variation in drive transistor characteristics has become important.

Various pixel circuits have been developed in order to correct the characteristics of a drive transistor (threshold value or mobility for example). However, as a result, the number of transistors or the number of control wires within a pixel has increased which is an obstacle to achieving high definition of the EL display device.

Therefore, a technology has been proposed in Japanese Laid Open Patent No. 2007-310311 for example which realizes simplification of a pixel circuit using two transistors and one capacitor as a means for achieving an EL display device with high definition.

FIG. 6 is a diagram which shows a circuit structure of a conventional EL display device disclosed in Japanese Laid Open Patent No. 2007-310311. A display part 11, video signal wire drive circuit 12, scanning wire drive circuit 13 and power supply wire drive circuit 14 are included in the EL display device 10. Furthermore, the display part 11 is arranged with a plurality of pixels in a matrix shape and a pixel circuit is arranged in each pixel. However, in order to simplify explanation, only the structure of one pixel circuit is shown in the display part 11.

Two transistors 15, 16, one capacitor 17 and a light emitting element 18 are included with in the display part 11. The source/drain terminals of the first transistor 15 are connected to the gate terminal of the second transistor 16 and the capacitor 17. In addition, the source terminal of the second transistor 16 is connected to the capacitor 17 and the light emitting element 18.

The video signal wire 19 is connected to the video signal wire drive circuit 12 and the source/drain terminals of the first transistor 15. The scanning wire 20 is connected to the scanning wire drive circuit 13 and the gate terminal of the first transistor 15. A first power supply wire is connected to the power supply wire drive circuit 14, the drain terminal of the second transistor 16 and also to the anode of light emitting element 18 via the second transistor 16. A second power supply wire 22 is connected to the cathode of the light emitting element 18.

In the EL display device 10 arranged with a pixel circuit having this type of structure, it is necessary to provide two values, [High] and [Low], to the first power supply wire 21, and supply a voltage while switching between [High] and [Low] to each row of each pixel arranged in a matrix. As a result, a method is adopted in which the first power supply wire 21 is included in common in a pixel of each row and a voltage supplied to the first power supply wire 21 in each row is switched in sequence by the power supply wire drive circuit 14.

Therefore, although there is a merit in being able to simplify the structure of a pixel circuit to be compatible with high definition, there is also a demerit whereby the area of a periphery region (what is called a frame region) of the display part 11 increases by the amount required for arranging the power supply wire drive circuit 14 on the exterior side of the display part 11 and there is room for further improvement.

### SUMMARY

One aspect of the present invention is a display device with a display part including a plurality of pixels wherein at least one of the plurality of pixels includes a video signal wire, a first power supply wire connecting via a first switch a first power supply outputting a first voltage (PVDD) and connecting via a second switch a second power supply outputting a second voltage (VRST) different to the first voltage, a second power supply wire connecting a third power supply outputting a third voltage (PVSS) different to the first voltage and the second voltage, a light emitting element arranged between the first power supply wire and the second power supply wire, a drive transistor (DRT) arranged between the first power supply wire and the light emitting element and controlling a value of a current supplied to the light emitting element, a third switch (SST) arranged between the video signal wire and a gate terminal of the drive transistor, and inputting a signal of the video signal wire to the gate terminal of the drive transistor, and a capacitor arranged between the gate terminal and source terminal of the drive transistor, the first power supply wire becoming the second voltage in a first time period within 1 horizontal scanning period, and becoming the first voltage in a remaining second time period.

Another aspect of the present invention is a method of driving a display device with a display part including a plurality of pixels, wherein at least one of the plurality of pixels includes a video signal wire, a first power supply wire connecting via a first switch a first power supply outputting a first voltage (PVDD) and connecting via a second switch a second power supply outputting a second voltage (VRST) different to the first voltage, a second power supply wire connecting a third power supply outputting a third voltage (PVSS) different to the first voltage and the second voltage, a light emitting element arranged between the first power supply wire and the second power supply wire, a drive transistor (DRT) arranged between the first power supply wire and the light emitting element and controlling a value of a current supplied to the light emitting element, a third switch (SST) arranged between the video signal wire and a gate terminal of the drive transistor, and inputting a signal of the video signal wire to the gate terminal of the drive transistor, and a capacitor arranged between the gate terminal and source terminal of the drive transistor, the first switch is set to an OFF state and the second switch is set to an ON state in a first time period within 1 horizontal scanning period, and the second voltage is provided to the first power supply wire, and the second switch is set to an OFF state and the first switch is set to an ON state in a second time period, and the first voltage is provided to the first power supply wire.

### BRIEF DESCRIPTION OF DRAWINGS

FIG. 1 is a diagram showing a schematic structure in an EL display device related to one embodiment of the present invention;

FIG. 2 is a diagram showing a circuit structure in an EL display device related to one embodiment of the present invention;

FIG. 3 is a diagram showing a time chart of a driving method in an EL display device related to one embodiment of the present invention;

FIG. 4 is a diagram showing a time chart of a driving method in an EL display device related to one embodiment of the present invention;

FIG. 5 is a diagram showing a time chart of a driving method in an EL display device related to one embodiment of the present invention; and

FIG. 6 is a diagram showing a circuit structure of an EL display device related to the prior art.

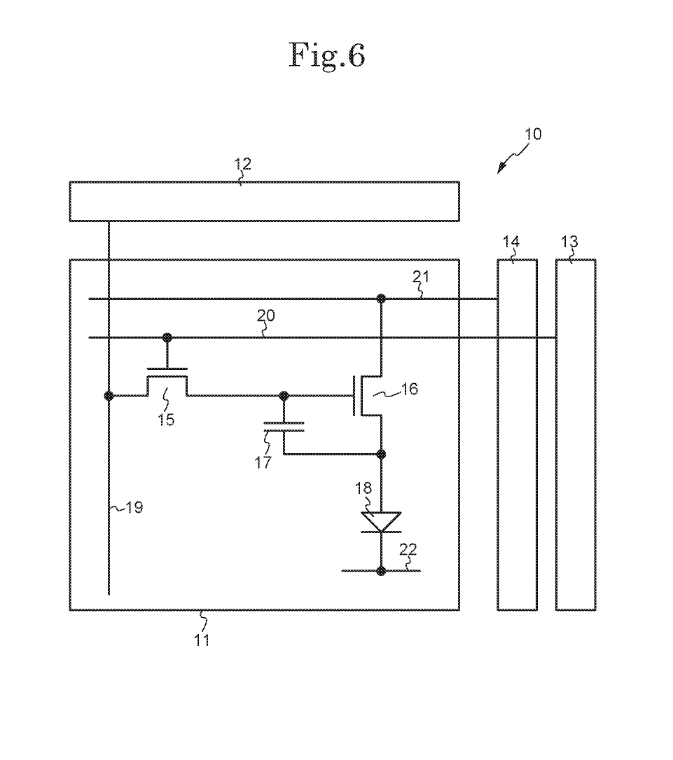

### DESCRIPTION OF EMBODIMENTS

One aim of the present invention is to provide an EL display device achieving both simplification of a pixel circuit and a reduction of a periphery region and a method of driving the EL display device.

Each embodiment of the present invention is explained below while referring to the diagrams. However, the present invention can be realized using various forms within a scope that does not depart from the concept of the present invention, and should not be interpreted as being limited to the content described in the embodiments exemplified below. In addition, in the present specification and each diagram, the same reference symbols are attached to elements in the diagrams that have already been explained or have the same or similar functions and overlapping explanations may be omitted.

### First Embodiment

### <Structure of a Display Device>

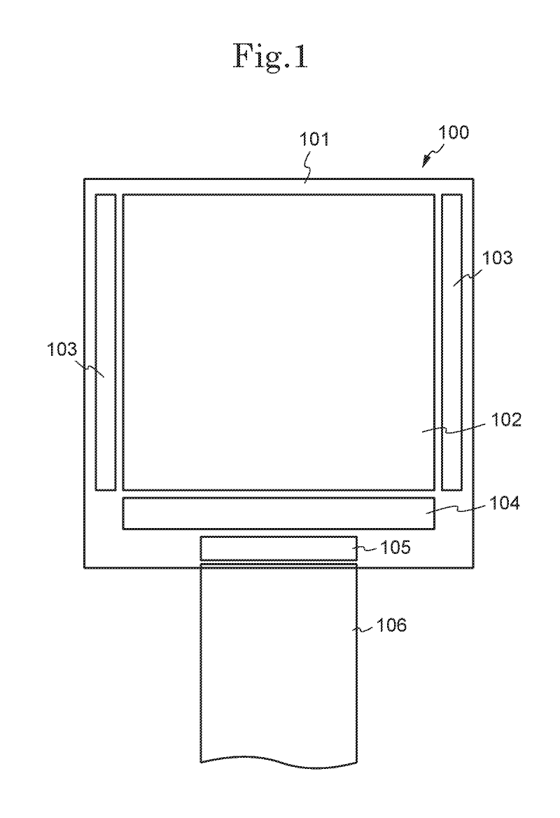

FIG. 1 is a diagram showing a schematic structure of an EL display device 100 related to the first embodiment of the present invention. The EL display device 100 is arranged with a display part (display region) 102, a scanning wire drive circuit 103, a video signal wire drive circuit 104 and logic circuit 105 formed above a substrate 101. The logic circuit 105 functions as a control part providing a timing signal etc to the scanning wire drive circuit 103 and video signal wire drive circuit 104. A FPC (Flexible Printed Circuit) 106 is a terminal for inputting a signal supplied from the exterior to the EL display device 100.

Furthermore, the video signal wire drive circuit 104 may include the logic circuit 105. In addition, although the logic circuit 105 is shown as being arranged by a flip chip method etc above the substrate 101 in FIG. 1, the logic circuit 105 may also be arranged and connected to the FPC 106.

A plurality of pixels is arranged in a matrix shape in the display part 102. A video signal is provided from the video signal wire drive circuit 104 according to video to be displayed in each pixel. By providing a current value controlled corresponding to these video signals to the light emitting element of each pixel, it is possible to display video in response to a video signal. Control of the current value provided to the light emitting element can be performed using a transistor.

In addition, although described below, the EL display device 100 of the present embodiment commonly controls a power supply wire in a plurality of pixels using two switches arranged in the logic circuit 105. As a result, the power supply wire drive circuit which was required in the conventional technology described previously is not necessary and it is possible to achieve a reduction of a periphery region. Consequently, it is possible to form the display part 102 by maximizing the use of the surface area of the substrate 101. The two switches may also be arranged not in the logic circuit 105 but in another logic circuit arranged separately.

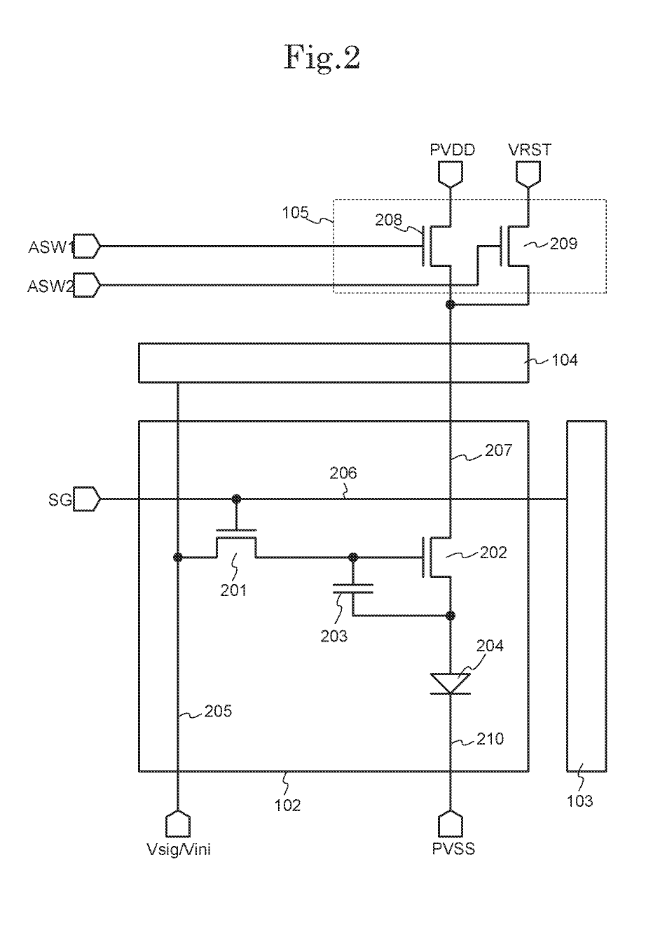

FIG. 2 is a diagram showing a circuit structure of the EL display device 100 related to the first embodiment. A plurality of pixels is arranged in a matrix shape in the display part 102 and a pixel circuit is arranged respectively in each pixel. In order to simplify explanation, only the structure of one pixel circuit is shown within the display part 102.

Two transistors 210, 202, one capacitor 203 and a light emitting element 204 are included within the display part 102. A drain terminal (or the source terminal) of the first transistor 201 (corresponding to the [third switch] described in the scope of the claims) is connected to the gate terminal of the second transistor 202 (corresponding to the [drive transistor] described in the scope of the claims) and the capacitor 203 (corresponding to the [capacitor] in the scope of the claims). In addition, the source terminal of the second transistor 202 is connected to the capacitor 203 and the light emitting element 204.

The video signal wire 205 is connected to the video signal wire drive circuit 104 and the source terminal (or drain terminal) of the first transistor 201, and is supplied with a video signal (Vsig) or an initial voltage (Vini). The scanning wire 206 is connected to the scanning wire drive circuit 103 and the gate terminal of the first transistor 201 and is supplied with a gate signal (SG).

The first power supply wire 207 is connected to the anode of the light emitting element 204 via the second transistor 202. Furthermore, the first power supply wire 207 is connected to the drain terminal of the first switch 208 and the drain terminal of the second switch 209 included in the logic circuit 105. The second power supply wire 210 is connected to the cathode of the light emitting element 204.

A first voltage (PVDD is supplied via the first switch 208 or a second voltage (VRST) is supplied via the second switch 209 to the first power supply wire 207. The first voltage is a fixed voltage output from a first power source (not shown in the diagram), and the second voltage is a fixed voltage output from a second power source (not shown in the diagram). In addition, a third voltage (PVSS) which is different to the first voltage and the second voltage is supplied to the second power supply wire 210. The third voltage is a fixed voltage output from a third power source (not shown in the diagram).

Furthermore, in the case where the second transistor 202 is an N channel type transistor, the first voltage, second voltage and third voltage have the following relationship: first voltage>second voltage>third voltage. That is, a relationship in which the second voltage is lower than the first voltage and the third voltage is lower than the second voltage is established.

The first switch 208 and second switch 209 can be arranged in common with respect to a plurality of pixels. For example, the switches may be arranged in common for each column or in common for each row with respect to a plurality of pixels arranged in a matrix shape. In addition, the switches may be arranged in common for each block formed by a plurality of pixels. Furthermore, the switches may be arranged in common in all the pixels which form the display part 102.

Here, the operation of the first switch 208 and second switch 209 is explained in detail. When a gate signal (ASW1) supplied to the gate terminal of the first switch 208 is a high level, the first switch 208 becomes an ON state (conductive state), ad when a gate signal (ASW2) supplied to the gate terminal of the second switch 209 is a low level, the second switch 209 becomes an OFF state (non-conductive state). As a result, the first voltage (PVDD) is supplied to the first power supply wire 207.

In addition, when the gate signal (ASW2) supplied to the gate terminal of the second switch 209 is a high level, the second switch 209 becomes an ON state, and when the gate signal (ASW1) supplied to the gate terminal of the first switch 208 is a low level, the first switch 208 becomes an OFF state. As a result, the second voltage (VRST) is supplied to the first power supply wire 207. That is, it is possible to switch a voltage supplied to the first power supply wire 207 just by exclusively switching between the first switch 208 and second switch 209.

In this way, the EL display device 100 of the first embodiment can perform voltage control of the first power supply wire 207 using a simple structure in which the voltage supplied to the first power supply wire 207 is switched using the second switch 208. As a result, it is not necessary to use a conventional power supply wire drive circuit and it is possible to realize a reduction of a periphery region. In addition, each pixel circuit is formed by two transistors and one capacitor and is compatible with simplification of a pixel circuit.

### <Driving Method of an EL Display Device>

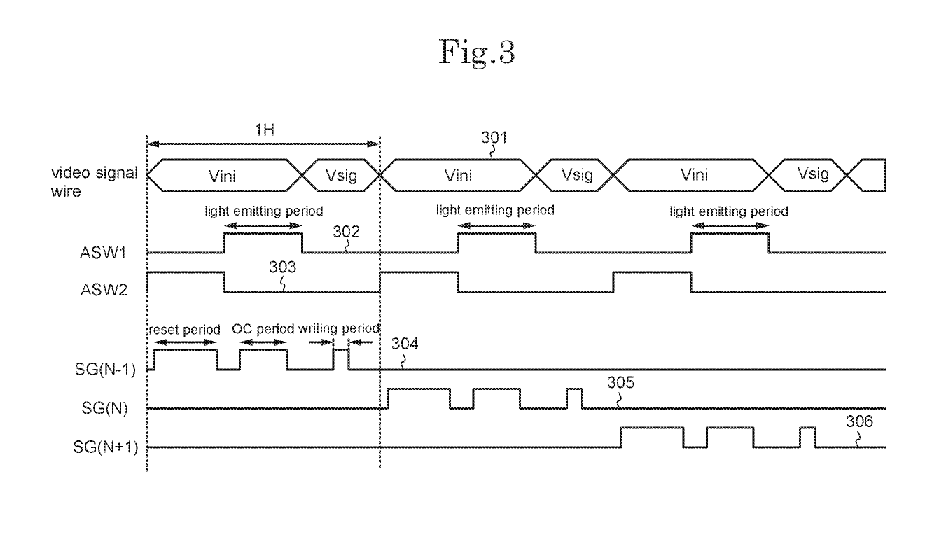

FIG. 3 is a diagram showing a time chart of a driving method in the EL display device 100 related to the first embodiment. In FIG. 3, [1H] means 1 horizontal scanning time period. The symbol 301 indicates a signal supplied to the video signal wire 205. Here, a time period shown by [Vini] is a time period in which an initial voltage is supplied, and a time period shown by [Vsig] is a time period in which a video signal is supplied.

The symbols 302 and 303 indicate the gate signal (ASW1) supplied to the first switch 208 and the gate signal (ASW2) supplied to the second switch 209 respectively. In addition, the symbols 304, 305 and 306 indicate a gate signal supplied to the N−1 row first transistor, a gate signal supplied to the Nth row first transistor 201, and a gate signal supplied to the N+1 row first transistor 201.

As is shown in FIG. 3, when the 1 horizontal scanning time period begins with respect to a pixel on the N−1 row, an initial voltage Vini is supplied to the video signal wire 205. In addition, the gate signal (ASW1) becomes a low level and the gate signal (ASW2) becomes a high level. That is, because the first switch 208 becomes an OFF state and the second switch 209 becomes an ON state, the second voltage (VRST) is supplied to the first power supply wire 207. As a result, the voltage of the source terminal and the drain terminal of the first transistor 202 (drive transistor) becomes the second voltage (VRST).

When the gate signal (SG) of the N−1 row scanning wire 206 becomes a high level in this state, the first transistor 201 (third switch) becomes an ON state, and the voltage of the gate terminal of the second transistor 202 becomes an initial voltage (Vini). When a certain time period has elapsed, the gate signal (SG) of the scanning wire 206 is returned to a low level. As a result of the operation up to this point, the second transistor 202 is returned to an initial state. A time period in which this series of reset operations is performed is shown by [reset time period] in FIG. 3.

Next, the gate signal (ASW1) becomes a high level and the gate signal (ASW2) becomes a low level. That is, the first switch 208 is switched to an ON state and the second switch 209 is switched to an OFF state. As a result, the first voltage (PVDD) is supplied to the first power supply wire 207 instead of the second voltage (VRST).

When the gate signal (SG) is set to a high level in this state, each voltage of the gate terminal, source terminal and drain terminal of the second transistor 202 become an initial voltage (Vini), the second voltage (VRST) and first voltage (PVDD) respectively. As a result, a current flows between the source terminal and drain terminal of the second transistor 202, and the voltage of the source terminal gradually rises from the second voltage (VRST) to a high voltage side.

Lastly, at the point when a voltage difference between the gate terminal and source terminal of the second transistor 202 becomes Vth (threshold voltage of the second transistor 202), the second transistor 202 becomes an OFF state. That is, at the point when the voltage of the source terminal of the second transistor rises to [Vini−Vth], the second transistor 202 becomes an OFF state. At this time, since a voltage corresponding to a threshold value (Vth) is held in the capacitor 203, variation in a threshold value between pixels of the second transistor 202 is compensated. The time period in which this series of offset cancel operations is performed is shown by [OC (offset cancel) time period] in FIG. 3.

When a sufficient time period has passed from the offset cancel operation, the gate signal (SG) is set to a low level and the first transistor 201 is set to an OFF state. It is desirable that this time period is set as long as possible so that the offset cancel operation is completely finished.

Next, the gate signal (ASW1) is switched to a low level and the gate signal (ASW2) and the gate signal (SG) are maintained at a low level. In this way, the first switch 208, second switch 209 and third switch 201 (first transistor) become an OFF state. A video signal (Vsig) is supplied to the video signal wire 205 in this state.

After the video signal (Vsig) is supplied to the video signal wire 205, the gate signal (SG) of the first transistor 201 is set to a high level and the video signal (Vsig) is supplied to the gate terminal of the second transistor 202 via the first transistor 201. At this time, a voltage corresponding to [Vsig−Vini+Vth] is held in the capacitor 203. A time period in which this series of writing operations is performed is indicated by [writing time period: in FIG. 3. When a certain period of time has elapsed, the gate signal (SG) is switched to a low level.

Preparation for making the light emitting element 204 emit light is complete by the operations described above. Next, when the gate signal (ASW1) becomes a high level (that is, when the first switch 208 becomes an ON state and a first voltage (PVDD) is supplied to the first power supply wire 207), a current flows to the light emitting element 204 via the second transistor 202 and a light emitting operation is performed. The time period in which this series of light emitting operations (display operation is performed is shown by [light emitting time period] in FIG. 3.

At this time, the value of a current which flows through the second transistor 202 is controlled according to the voltage held in the capacitor 203. In this way, the light emitting element 204 emits light at a luminosity in response to a video signal and it is possible to perform a display operation.

The reset time period, offset cancel time period and writing time period are performed within 1 horizontal scanning time period with respect to a N−1 row pixel. Following this, the same operations are repeated in sequence with respect to an Nth row pixel and N+1 row pixel and by finally performing the processing for all the pixels, it is possible to display an intended image.

### Second Embodiment

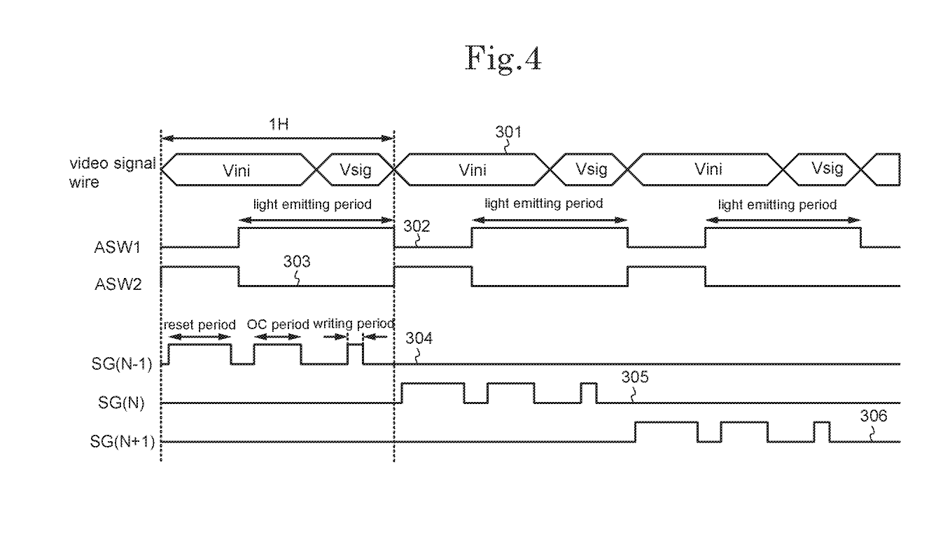

FIG. 4 is a diagram showing a time chart of a driving method of an EL display device related to the second embodiment. The difference from the first embodiment is that in the driving method of the second embodiment, after the gate signal (ASW1) is set to a high level, the high level is maintained until the 1 horizontal scanning time period is completed. The structure of the EL display device, basic driving method and other structures are the same as the EL display device 100 related to the first embodiment.

As is shown in FIG. 4, when a 1 horizontal scanning time period with respect to each pixel on an N−1 row starts, an initial voltage Vini is supplied to the video signal wire 205. In addition, the gate signal (ASW1) is set to a low level, the first switch 208 is set to an OFF state, the gate signal (ASW2) is set to a high level and the second switch 209 is set to an ON state. In this way, the second voltage (VRST) is supplied to the first power supply wire 207.

When the gate signal (SG) of the N−1 row scanning wire 206 becomes a high level in this state, the first transistor 201 (third switch) becomes an ON state, and the voltage of the gate terminal of the second transistor 202 becomes an initial voltage (Vini). When a certain time period has elapsed, the gate signal (SG) of the scanning wire 206 is returned to a low level. As a result of the operation up to this point, the second transistor 202 returns to an initial state (reset time period).

Next, the gate signal (ASW1) becomes a high level and the gate signal (ASW2) becomes a low level. In this way, since the first switch 208 is switched to an ON state and the second switch 209 is switched to an OFF state, a first voltage (PVDD) is supplied to the first power supply wire 207. When the gate signal (SG) is set to a high level in this state, the second transistor 202 becomes a conductive state and a current flows, and lastly the current stops at the point when a voltage corresponding to a threshold value (Vth) of the second transistor 202 is held in the capacitor 203 (offset cancel time period). When a certain time period has elapsed, the gate signal (SG) is set to a low level and the first transistor 291 is set to an OFF state. It is desirable that this time period is set as long as possible so that the offset cancel operation is completely finished.

At this time, since the gate signal (ASW1) is maintained at a high level, the gate signal (ASW2) is maintained at a low level, and the gate signal (SG) becomes a low level, the first switch 208 is maintained in an

ON state, the second switch 209 is maintained in an OFF state and the third switch 201 (first transistor) becomes an OFF state. Furthermore, the gate signal (ASW1) is maintained at a high level until the 1 horizontal scanning time period is completed.

In this state, the video signal (Vsig) is supplied to the video signal wire 205. After the video signal (Vsig) is supplied to the video signal wire 205, the gate signal (SG) of the first transistor 201 is set to a high level and the video signal (Vsig) is supplied to the gate terminal of the second transistor 202 via the first transistor 201. At this time, because the first voltage (PVDD) is supplied to the first power supply wire 207 at the point when the video signal (Vsig) is written to the gate terminal of the second transistor 202, a current flows to the second transistor 202 and a correction in mobility is simultaneously performed. When a certain period of time has elapsed, the gate signal (SG) is switched to a low level.

Preparation for making the light emitting element 204 emit light is complete by the operations described above. Next, when the gate signal (ASW1) becomes a high level, a current flows to the light emitting element 204 via the second transistor 202 and a light emitting operation is performed. As described above, since the gate signal (ASW1) is maintained at a high level until the 1 horizontal scanning time period is finished, the light emitting time period is also extended until the 1 horizontal scanning time period is finished. As a result, it is possible to secure a long light emitting time period and improve the luminosity of the EL display device 100.

As described above, according to the driving method related to the second embodiment, in addition to the effects explained in the first embodiment, because it is possible to secure a long light emitting time period, the effect of being able to improve the luminosity of the EL display device is also demonstrated. Furthermore, it is also possible to correct mobility of the second transistor 202 during a writing time period.

### Third Embodiment

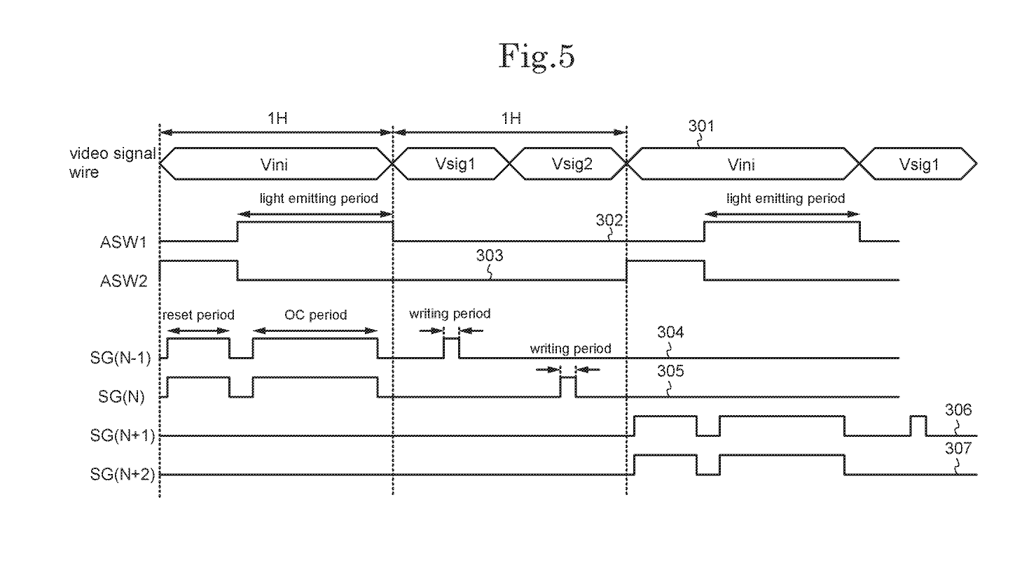

FIG. 5 is a diagram showing a time chart of a driving method of an EL display device related to the third embodiment. The difference from the first embodiment is that in the driving method of the third embodiment, after the gate signal (ASW1) is set to a high level, the high level is maintained until the 1 horizontal scanning time period is completed, and the reset time period and offset cancel time period are simultaneously performed on a plurality of rows. The structure of the EL display device, basic driving method and other structures are the same as the EL display device 100 related to the first embodiment.

As is shown in FIG. 5, when the 1 horizontal scanning time period begins for each pixel on two rows, N−1 row and Nth row, an initial voltage (Vini) is supplied to the video signal wire 205. Since the video signal wire 205 is common to each column, the initial voltage (Vini) is supplied to the video signal wire 205 in each pixel on two rows, N−1 row and Nth row.

Next, the gate signal (ASW1) is set to a low level, the first switch 208 is set to an OFF state, the gate signal (ASW2) is set to a high level and the second switch 209 is set to an ON state. In the present embodiment, since the first power supply wire 207 is also common across a plurality of rows, the second voltage (VRST) is supplied to the first power supply wire 207 in each pixel on two rows, N−1 row and Nth row.

When the gate signal (SG) of the N−1 row scanning wire 206 becomes a high level in this state, the first transistor 201 (third switch) becomes an ON state, and the voltage of the gate terminal of the second transistor 202 becomes an initial voltage (Vini). When a certain time period has elapsed, the gate signal (SG) of the scanning line 206 is returned to a low level. As a result of the operations up to this point, the second transistor 202 returns to an initial state (reset time period).

Next, the gate signal (ASW1) becomes a high level and the gate signal (ASW2) becomes a low level. In this way, since the first switch 208 is switched to an ON state and the second switch 209 is switched to an OFF state, the first voltage (PVDD) is supplied to the first power supply wire 207. In the present embodiment, since the first power supply wire 207 also becomes common across a plurality of rows, the first voltage (PVDD) is supplied to the first power supply wire 207 in each pixel on two rows, N−1 row and Nth row.

When the gate signal (SG) is set to a high level in this state, the second transistor 202 becomes a conductive state, a current begins to flow, and finally the current is stopped at the point when a voltage corresponding to a threshold value (Vth) of the second transistor 202 is held in the capacitor 203 (offset cancel time period). In the present embodiment, because an offset cancel operation is performed for two rows simultaneously, it is possible to maintain the gate signal (SG) at a high level until near completion of the 1 horizontal scanning time period. That is, since it is possible to secure a long offset cancel operation, it is possible to more completely end an offset cancel operation. That is, it is possible to accurately store a voltage corresponding to a threshold value of the second transistor 202 in the capacitor 203.

Next, when a new 1 horizontal scanning time period starts, a video signal (Vsig1) is supplied to the video signal wire 205 and the gate signal (SG) is also switched to a low level. At this time, the gate signal (ASW2) is maintained at a low level and the gate signal (SG) is maintained at a low level. In this way, the first switch 208 is switched to an OFF state, the second switch 209 is switched to an OFF state, and the third switch 201 (first transistor) is maintained in an OFF state.

After the video signal (Vsig1) is supplied to the video signal wire 205, the gate signal (SG) of the first transistor 201 in a pixel on a N−1 row is set to a high level for a certain time period and the video signal (Vsig1) is supplied to the gate terminal of the second transistor 202 via the first transistor 201. In this way, a writing operation of the video signal (Vsig1) to the capacitor 203 in a pixel on an N−1 row is complete.

Next, a video signal (Vsig2) is supplied to the video signal wire 205. After the gate signal (SG) of the first transistor 201 in a pixel on an Nth row is set to a high level for a certain time period, the video signal (Vsig2) is supplied to the gate terminal of the second transistor 202 via the first transistor 201. In this way, a writing operation of the video signal (Vsig2) to the capacitor 203 in a pixel on an Nth row is complete.

Preparation for making the light emitting element 204 is complete by the operations described above. In addition, next when the gate signal (ASW1) becomes a high level, a current flows to the light emitting element 204 via the second transistor 202 and a light emitting operation is performed. As described above, because the gate signal (ASW1) is maintained at a high level until the 1 horizontal scanning time period is finished, the light emitting time period is also extended until the 1 horizontal scanning time period is finished. As a result, it is possible to secure a long light emitting time period and improve the luminosity of the EL display device 100.

The reset time period, offset cancel time period and writing time period described above are performed within two horizontal scanning time periods for a pixel on a N−1 row and Nth row. Following this, the same operation is repeated in sequence for pixels on an N+1 row and N+2 row, and by finally performing processing for all the pixels, it is possible to display an intended image.

Furthermore, although an example is exemplified in which a reset operation and offset cancel operation are performed for every two rows in the present embodiment, it is also possible to perform a reset operation and offset cancel operation for a plurality of rows such as four rows and six rows.

As described above, according to the driving method related to the third embodiment, in adding to the effects explained in the first embodiment, the effect of being able to improve the luminosity of the EL display device is also demonstrated by securing a long light emitting time period. Furthermore, since it is also possible to secure a long offset cancel time period, it is possible to perform a more complete offset cancel operation and further reduce the effects of a variation in characteristics of a drive transistor.

In addition, although the connection and voltage relationship in the case where a transistor forming a pixel is an N channel type transistor was described in the present invention, the concept of the present invention can also be realized using a P channel type transistor. In this case, the present invention can be realized by changing the definition of a source and drain and size relationship of a power supply voltage within a scope that does not produce a contradiction in the direction of a current to a light emitting element.

Although a person skilled in the art of the present invention could appropriately add, remove or change the design of structure elements or add, omit or change the conditions of processes based on the EL display device explained as an embodiment of the present invention, as long as the gist of the present invention is provided, these are included in the scope of the present invention.

In addition, other operational effects which are different to the operational effects brought about by the embodiments described above, those that are obvious from the descriptions in the present specification or those that could easily be predicted by a person ordinarily skilled in the art are also to be interpreted as being brought about by the present invention.

What is claimed is:

1. A display device with a display part including a plurality of pixels comprising:
at least one of the plurality of pixels includes
a video signal wire;
a first power supply wire connecting via a first switch a first power supply outputting a first voltage and connecting via a second switch a second power supply outputting a second voltage different to the first voltage;
a second power supply wire connecting a third power supply outputting a third voltage different to the first voltage and the second voltage;
a light emitting element arranged between the first power supply wire and the second power supply wire;
a drive transistor arranged between the first power supply wire and the light emitting element and controlling a value of a current supplied to the light emitting element;
a third switch arranged between the video signal wire and a gate terminal of the drive transistor, and inputting a signal of the video signal wire to the gate terminal of the drive transistor; and
a capacitor arranged between the gate terminal and source terminal of the drive transistor;
the first power supply wire becoming the second voltage in a first time period within 1 horizontal scanning period, and becoming the first voltage in a remaining second time period.

2. The display device according to claim 1, wherein the drive transistor is an N channel type transistor, the second voltage is lower than the first voltage, and the third voltage is lower than the second voltage.

3. The display device according to claim 1, wherein the first switch and the second switch are controlled in common with respect to at least two or more pixels selected from the plurality of pixels.

4. The display device according to claim 1, wherein the plurality of pixels is arranged in a row direction and column direction, and the first switch and the second switch are controlled in common for each column.

5. The display device according to claim 1, wherein the first switch and the second switch are controlled in common in all of the plurality of pixels.

6. The display device according to claim 1, wherein the first switch and the second switch are arranged.

7. The display device according to claim 1, wherein a reset operation of the drive transistor is performed in the first time period, and an offset cancel operation of the drive transistor is performed in the second time period.

8. A method of driving a display device with a display part including a plurality of pixels comprising:
at least one of the plurality of pixels includes
a video signal wire;
a first power supply wire connecting via a first switch a first power supply outputting a first voltage and connecting via a second switch a second power supply outputting a second voltage different to the first voltage;
a second power supply wire connecting a third power supply outputting a third voltage different to the first voltage and the second voltage;
a light emitting element arranged between the first power supply wire and the second power supply wire;
a drive transistor arranged between the first power supply wire and the light emitting element and controlling a value of a current supplied to the light emitting element;
a third switch arranged between the video signal wire and a gate terminal of the drive transistor, and inputting a signal of the video signal wire to the gate terminal of the drive transistor; and
a capacitor arranged between the gate terminal and source terminal of the drive transistor;
the first switch is set to an OFF state and the second switch is set to an ON state in a first time period within 1 horizontal scanning period, and the second voltage is provided to the first power supply wire; and
the second switch is set to an OFF state and the first switch is set to an ON state in a second time period, and the first voltage is provided to the first power supply wire.

9. The method of driving a display device according to claim 8, wherein the drive transistor is an N channel type transistor, the second voltage is lower than the first voltage, and the third voltage is lower than the second voltage.

10. The method of driving a display device according to claim 8, wherein a reset operation of the drive transistor is performed in the first time period in the 1 horizontal scanning period, and an offset cancel operation of the drive transistor is performed in the second time period.

11. The method of driving a display device according to claim 10, wherein a reset operation and an offset cancel operation with respect to a plurality of rows of pixels are performed within the 1 horizontal scanning period.

12. The method of driving a display device according to claim 8, wherein the third switch is set to an ON state and an initial voltage is applied to the video signal wire in the first time period within the 1 horizontal scanning period, and a threshold value of the drive transistor is stored in the capacitor in the second time period.

13. The method of driving a display device according to claim 8, wherein the second time period is a remaining time period obtained by subtracting the first time period from the 1 horizontal scanning period.

14. The method of driving a display device according to claim 8, wherein the first switch and the second switch are controlled in common with respect to at least two or more pixels selected from the plurality of pixels.

15. The method of driving a display device according to claim 8, wherein the plurality of pixels is arranged in a row direction and column direction, and the first switch and the second switch are controlled in common for each column.

16. The method of driving a display device according to claim 8, wherein the first switch and the second switch are controlled in common in all of the plurality of pixels.
